(19) United States
(12) Patent Application Publication
(10) Pub. No.: US 2003/0163528 A1
(43) Pub. Date: Aug. 28, 2003

(54) Multicasting system and method for providing personalized content

(75) Inventors: Dwip N. Banerjee, Austin, TX (US); Rabindranath Dutta, Los Angeles, CA (US)

Correspondence Address: Edmond A. DeFrank, 20145 Via Medici, Northridge, CA, 91326, US

(73) Assignee: International Business Machines Corporation, Armonk, NY

(21) Appl. No.: 10/087,940

(22) Filed: Feb. 27, 2002

(51) Int. Cl. G06F 15/16; G06F 15/173

(52) U.S. Cl. 709/205; 709/242

(57) ABSTRACT

The present invention is embodied in a multicasting system and method of a network for providing personalized content to remote users of the network having different bandwidths. The personalized content includes Internet and World Wide Web (WWW) content. In general, the present invention allows the user to communicate within a network utilizing a multicast design. The host establishes group membership for the multicast group and then establishes an individualized set of broadcast criteria. This is accomplished by another process that registers streams of interest for the host. Should any member of the group broadcast data, the group system disseminates the data into discrete segments. The system then refers to the stream of interest register to determine which segments of the broadcast will be sent to which hosts in the network.

### BACKGROUND OF THE INVENTION

1. Field of the Invention

The present invention relates in general to computer networks and more particularly to a multicasting system and method for providing personalized content to remote network users that connect to the network with different bandwidths. The personalized content includes content found on the World Wide Web (WWW) of the Internet.

2. Related Art

Computer networks are widely used as a way to communicate messages between computers. The Internet is made up of more than 100,000 interconnected computer networks spread across over 100 countries, including commercial, academic and government networks. Originally developed for the military, the Internet has become widely used for academic and commercial research. Today, the Internet has become commercialized into a worldwide information highway, providing information on every subject known to humankind. Similarly, businesses and other entities have adopted the Internet paradigm as a model for their internal networks, or so-called “intranets.”

Traditional network computing applications have involved communication between two computers. However emerging applications, including LAN TV, desktop conferencing, corporate broadcasts, and collaborative computing, require simultaneous communication between groups of computers. This process is known generically as multipoint communications. Three ways to design multipoint networking applications are unicast, broadcast and multicast.

With a multicast design, applications can send one copy of each packet and address it to the group of computers that want to receive it. This technique addresses packets to a group of receivers rather than to a single receiver. The system depends on the network to forward the packets to only the networks that need to receive them. Many multipoint applications are valuable because they are not limited to a single LAN. However, they are typically extended to an Internet consisting of different media types such as Ethernet, Token Ring, FDDI, ATM, Frame Relay, SMDS, and other networking technologies. Thus, it is desirable to implement multicast as the network layer.

In order to support multicast communications, the address, dynamic registration and multicast routing of the network layer are defined. The dynamic registration is a mechanism for the computer to communicate to the network that it is a member of a particular group. This allows the computer to receive traffic from the network, for the group. Fundamental is a program, called a process, joining a multicast group on a given interface on a host. Membership in this multicast group on the given interfaces is dynamic as it changes over time as processes join and leave the group.

The address allows communication with a group of receivers and must be mapped onto the data-link layer multicast address where they exist. In the IP address space, Class D is reserved for multicast traffic, and the Internet Group Management Protocol (IGMP), is used by hosts and routers that support multicasting. It lets all the systems on a physical network know which hosts currently belong to which multicast group. This information is required by the multicast routers, so they know which multicast datagrams to forward onto which interfaces.

Multicast routing allows the network to send packets to all receivers through gateways generally known as routers. These routers act as packet distribution trees. If there are multiple receivers on a given branch, only one copy of the packet should exist on that branch. In this process the routers also connect networks that make up the group, generally through physical connections, or ports. The determination of the appropriate gateway for a particular IP (Internet Protocol) datagram is called routing.

Messages transferred between computers within a network are typically broken up into plural data packets. Packet switching systems are used to route the data packets to their required destination and enable the efficient handling of messages of different lengths and priorities. Since each data packet includes a destination address, all packets making up a single message do not have to travel the same path. Instead, the data packets can be dynamically routed over the interconnected networks as circuits become available or unavailable. The destination computer receives the data packets and reassembles them back into their proper sequence to reconstruct the transmitted message.

Internet computer networks generally use the TCP/IP communications protocol, which is an acronym for Transmission Control Protocol/Internet Protocol. The TCP portion of the protocol provides the transport function by breaking a message into smaller packets, reassembling the packets at the other end of the communication network, and re-sending any packets that get lost along the way. The IP portion of the protocol provides the routing function by giving the data packets an address for the destination network and client at the destination network. Each data packet communicated using the TCP/IP protocol includes a header portion that contains the TCP and IP information.

Another communication protocol used in communication between Internet computer networks is UDP/IP, in which UDP is an acronym for User Datagram Protocol. UDP is used in place of TCP in conditions when a reliable delivery is not required. For example, UDP/IP is often used for real-time audio and video traffic where lost data packets are simply ignored, because there is no time to retransmit. Since the computer networks connected to the Internet may use other communication protocols besides TCP/IP or UDP/IP, gateways are used to convert data packets from these protocols into the other protocols.

At a destination network, one or more routers may be utilized to receive incoming data packets and route the packets to other internal networks such as local area networks (LAN). The internal networks may further include servers that supply information to one or more clients. The servers are generally highspeed microcomputers, minicomputers or even mainframes. In some cases, the clients are internal to the network (i.e., at the back-end), and the router acts as a conduit for communication of data packets between the clients and the outside world. The back-end servers may provide various application functions for the clients, such as a database server that maintains the databases and processes requests from clients to extract data from or update the databases.

In other cases, the clients are external to the network (i.e., at the front-end), and the router acts as a conduit for communication of data packets between the clients and the back-end servers. For example, an Internet application server at the back-end may host Web applications within the network that are accessed by clients outside the network. In still other cases, the clients are both internal and external to the network. The routers perform the functions of switching data packets between the internal and external networks, and balancing the load placed upon the back-end servers of the internal network by distributing message packets between the back-end servers in the most efficient and expeditious manner.

In view of the high volume of message traffic that they process and the relatively limited kinds of tasks that they perform, routers typically comprise dedicated switching processors having an architecture optimized to provide these functions. A drawback of such dedicated switching processors is that they can be very expensive due in part because they are manufactured in relatively low volumes as compared with other general-purpose computer systems. Moreover, the software that provides the message routing and load balancing functions must be written specifically for the dedicated switching processors, which further increases the cost of purchasing, operating and maintaining such systems. An additional drawback of dedicated switching processors is that most modifications to their functionality require a hardware change, which is typically more expensive and difficult than a software change.

It would therefore be very desirable to provide the message routing and load balancing functions of a network router within a general-purpose symmetrical multiprocessor (SMP) computer system. Such general-purpose multiprocessor computer systems are less expensive than conventional systems due to their larger volume production, and changes to their functionality can be readily accomplished by modifying their software rather than their hardware.

The complete Internet consists of a large number of interconnected autonomous systems (ASs) each of which constitutes a distinct routing domain. Within an AS, routers communicate with each other using protocols. The most common interior gateway protocols (IGPs) are the Routing Information Protocol (RIP) and the Open Shortest Path First (OSPF) protocol. These protocols allow the routers to exchange locally obtained information and to maintain an up to date routing table, or list, of the addresses of group members.

If a computer wishes to transmit an IP datagram, it determines the physical address of the destination computer from a routing table. The table could be configured into a file and read into memory at boot up time, or use a protocol known as Address Resolution Protocol (ARP). This operates dynamically to maintain the translation table called the ARP cache. A computer connected to a number of networks will have a separate ARP cache for each interface so that communication with one group is kept discreet from another. A group transferring multi-media information through a multicast route would share information on a routing table identifying the members of that group. With the maturing of the Web and multimedia capabilities and the steady incorporation of broadband infrastructures, there will be a proliferation of multimedia broadcast on ASs, such as Video-on-demand, corporate multimedia presentations, video conferencing, etc.

However, congestion is a major problem on a network such as the Internet. In order to alleviate the congestion, the use of IP multicasting is increasing. Multicast routers are sometimes used to communicate with other routers with an interest in the transmission, and the contents are propagated to the end user. A collection of such multicast routers facilitates the transmission of data without unnecessary duplication and therefore conserves the resources of the Web server.

Despite the growth of the Internet, the “broadband revolution” has expanded in a disparate manner. In different regions the infrastructure gap between sectors is widening. To enable Internet access to nodes in all regions the issue of congestion must be addressed. In addition a system sensitive to the specific needs of each node in each region needs to be incorporated. For example one type of node may only require audio transmissions, another may require text, and another may require video. Each scenario imposes various bandwidths and space to meet the requirements of the various nodes. While IP multicasting causes a reduction in congestion, it has a major limitation in addressing the issue of bandwidth mismatch among its nodes of interest.

Therefore, what is needed is a multicasting system and method for providing personalized content to users having different bandwidths while retaining multicasting efficiency. The system would address the issue of bandwidth mismatch among its nodes of interest, and consistent with the Unicast model of the Web, would facilitate the transmission of personalized data with regard to the infrastructure capabilities of hosts and receivers.

### SUMMARY OF THE INVENTION

To overcome the limitations in the prior art described above, and to overcome other limitations that will become apparent upon reading and understanding the present specification, the present invention is embodied in a multicasting system and method of a network for providing personalized content to remote users of the network having different bandwidths. The personalized content includes Internet and World Wide Web (WWW) content.

In general, the present invention allows a host server to effectively communicate with a wide variety of users utilizing a novel multicasting system, even if the variety of users has differing bandwidth capabilities. Namely, in one embodiment, first, a user expresses his/her desire to enter a multicast group controlled by a multicasting system. Second, the user identifies his/her particular streams of interest to the multicasting system. Third, the user joins the desired multicast group. Fourth, the user receives specified content streams based on the user's identified streams of interest. When the user is done observing the stream, the user leaves multicast group.

In operation, the host server designates portions of the content to plural multicast routers. Each user registers data streams of interest. Each user is then associated with a multicast router that corresponds to the geographical locale of the particular user and the data stream of interest registered by the user. Last, the content is transmitted to the users via the multicast routers. In particular, the content is preferably delivered hierarchically from the host sever at a top level that controls the entire portion of the content to the plural multicast routers at the mid level that receive the designated portions of the content that they are capable of accommodating. The mid level then sends the content to the users at a lowest level, which receive parts of the designated portions representing respective user registered data streams of interest.

In this embodiment, preferably, discrete streams of information are forwarded through multicast routers to host servers within the network. The multicast routers utilize current unused segments in the Internet Group Management Protocol (IGMP) to communicate data streams of interest in addition to multicast groups of interest to other multicast routers. In this way the relevant routers have information about the interests of other routers.

When content is generated by a host in the network, multicast routers consult the interest lists of other routers, and forward them only the content in which they have indicated interest. These routers do the same for other routers and so on. Finally the user's multicast router receives the data streams in which it has shown interest, and forwards only those streams to the user.

The present invention as well as a more complete understanding thereof will be made apparent from a study of the following detailed description of the invention in connection with the accompanying drawings and appended claims.

### BRIEF DESCRIPTION OF THE DRAWINGS

Referring now to the drawings in which like reference numbers represent corresponding parts throughout:

FIG. 1 is a general block diagram showing an overview of the present invention.

FIG. 2 is a block diagram illustrating the address system of the present invention.

FIG. 3 is a block diagram illustrating the dynamic address system the present invention.

FIG. 4 is a block diagram illustrating the stream register system of the present invention.

FIG. 5 is a block diagram illustrating a working example of the present invention.

FIG. 6 is a general flow diagram of a working example of the present invention.

FIG. 7 is a detailed flow diagram of a working example of the present invention.

FIG. 8 is a block diagram illustrating a practical working example in an Internet environment in accordance with the present invention.

### DETAILED DESCRIPTION OF THE INVENTION

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

I. Introduction

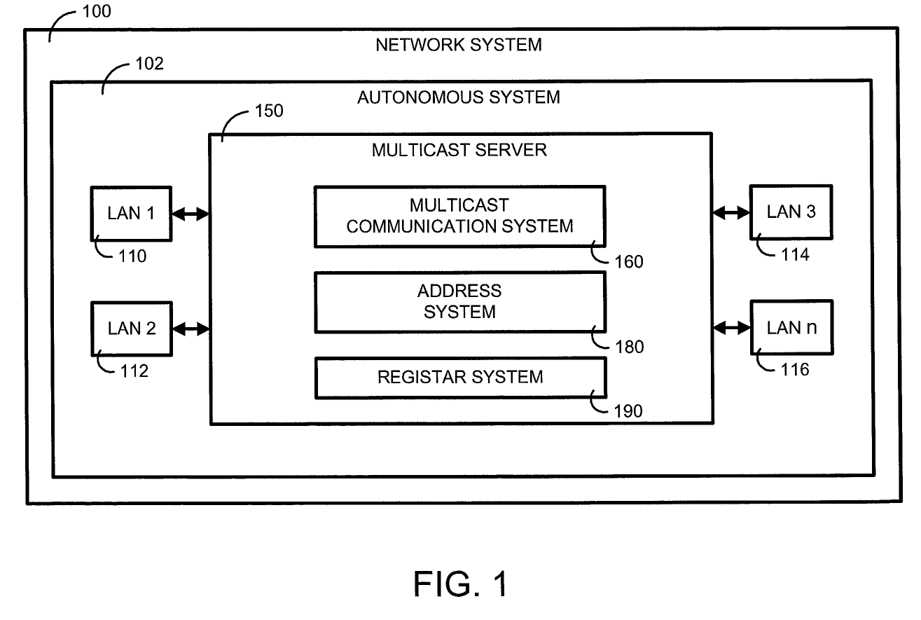

FIG. 1 is a general block diagram showing an overview of the present invention. The network system 100 includes a working domain, autonomous system 102 that defines the limits of the system. The working domain can be any predefined area, such as a LAN, WAN, Internet, etc. The autonomous system 102 includes a multicast server 150 that operates functionally to link the LANs, 110, 112, 114, 116, which for illustrative purposes only are used to describe the working domain. The LANs 1-n, 110, 112, 114, 116, could be any combination of networks, and the computers comprising those networks, that are linked by an address system to exchange information through a multicast routing process.

As known in the art, a network switch is a device that cross connects network nodes or LAN segments and allows full bandwidth to pass between connected nodes. Alternatively, the internal or external switches could be provided by a network hub, which is a device that connects nodes by sharing the bandwidth between the connected nodes. Network switches are advantageous over network hubs in view of their greater capacity and speed. As also known in the art, a router is a device that routes data packets between networks. Routers read the network address in each transmitted data packet and make a decision on how to send it based on the most expedient route (traffic load, line costs, speed, bad lines, etc.).

Alternatively, the router may be provided by a network switch or hub. It should be appreciated that various alternative network configurations are anticipated, and moreover, that the numbers of clients, backend servers and network channels are not intended to limit the scope of the invention in any way. This might involve a host communicating with itself, or with any other host in the autonomous system 102. The multicast server 150, includes a number of subsystems that also facilitate communication within hosts in the LANs 110, 112, 114, 116, or between such hosts. These include the multicast communication system 160, the address system 180 and the register system 190.

In general, the multicast communication system 160 effectively communicates with a wide variety of users utilizing the multicasting server 150 of the present invention, even if the variety of users has differing bandwidth capabilities and streams of interest. This can be accomplished by having the multicast communication system 160 include multicast routers located on a subnet for receiving requested streams of interest. From this, the multicast routers make notes of the requested streams, and then add the streams to their list of streams of interest (by analyzing all user multicast requested streams). This will produce the particular router's streams of interest. By extending (or slightly expanding) current protocols, such as IGMP, multicast routers can communicate their streams of interest in addition to multicast groups of interest to other multicast routers. As a result, the relevant routers will have information about the interests of other routers.

II. Details of the Components and Operation

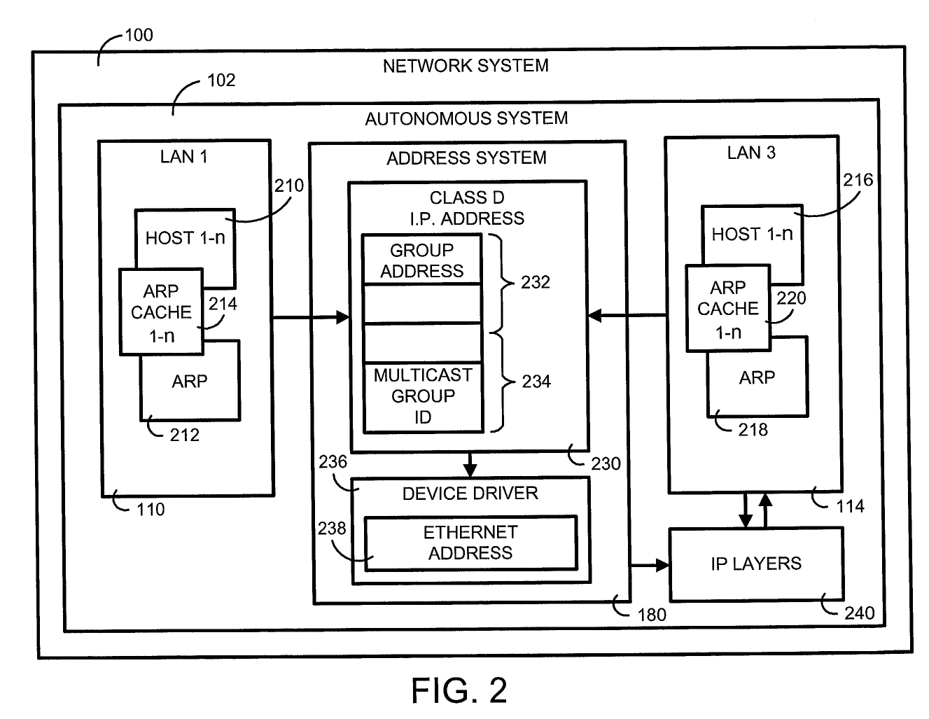

FIG. 2 is a block diagram illustrating the address system 180 in a preferred embodiment of the current invention. Referring to FIG. 2 along with FIG. 1, first, the LANs 110 and 114 shown in this figure but are representative of all LANs in the autonomous system 102, contain hosts 1-n, 210, 216. If a host 1-n, 210, is to transmit an IP datagram it needs to be encapsulated in a frame appropriate to the physical medium of the network.

The IP datagram is the basic unit of information passed across a TCP/IP internet. An IP datagram is to an Internet as a hardware packet is to a physical network. It contains a source and destination address along with data. For the successful transmission of the frame it is necessary to determine the physical address of the destination computer, in this instance host 1-n, 216. This can be achieved fairly simply using a table that will map IP addresses to physical addresses.

Typically, the computer uses a protocol known as ARP (Address Resolution Protocol) 212, 218 that operates dynamically to maintain the translation table known as the ARP cache 1-n 214, 220. Address Resolution Protocol is the TCP/IP protocol used to dynamically bind a high level IP address to a low-level physical hardware address. ARP is only across a single physical network and is limited to networks that support hardware broadcast.

The host 1-n 210, determines its own physical address at boot up by examining the hardware and its own IP address from a configuration file, but it is necessary to fill the ARP cache 1-n, 214. This is done by the computer making ARP 212, 218 broadcasts whenever it encounters an IP address that cannot be mapped to a physical address by consulting the cache. By making such requests a host can fill up the ARP cache 1-n, 214, 220.

If a host 1-n 210, 216, is connected to more than one network via separate interfaces, then a separate ARP cache will be maintained for each interface. Alternatively there will be a further entry in the ARP cache 1-n, 214, 220, associating an entry with a particular interface. Since ARP 212,218 requests are broadcast, any host maintaining an ARP cache can monitor the broadcasts and extract the host's physical and IP address and update its own ARP cache as necessary. The ARP request format is designed to be capable of supporting protocols other than IP and Ethernet as long as it is possible to broadcast on the local network 102.

IP addresses can be of A, B, C or D class. The class D IP address 230 is used in multicast and has the format: “1 1 1 0 (232) multicast group ID (234)” with 28 bits allocated for the multicast ID having no further structure. The set of hosts 1-n 210, 216, listening to a particular IP multicast address is called a host group. A host can span multiple networks, such as the autonomous system 102. Hosts may join and leave host groups at will, but it should be noted that a host does not have to belong to a group to send a message to the group.

Some multicast group addresses are assigned by the IANA (Internet Assigned Numbers Authority), and are called permanent host groups. This is similar to TCP and UDP port numbers. The IANA owns the Ethernet address block and allocates half of this block for multicast addresses. In the Ethernet address 23 bits correspond to the IP multicast group ID 234 which is unused, the other section is the group address 232. IP addresses are allocated by other services including the Network Information Center and the Internet Service Provider or direct from regional registries.

Multicasting on a single physical network typically works as follows. The sending process specifies a destination IP address that is a multicast address, the device driver 236 converts this to the corresponding Ethernet address 238 and sends it. The receiving process must notify their IP layers 240 that they want to receive datagrams destined for a given multicast address, and the device driver 236 must enable reception of these multicast frames. This is called joining a multicast group. When a multicast datagram is received by a host, it must deliver a copy to all the processes that belong to the multicast group.

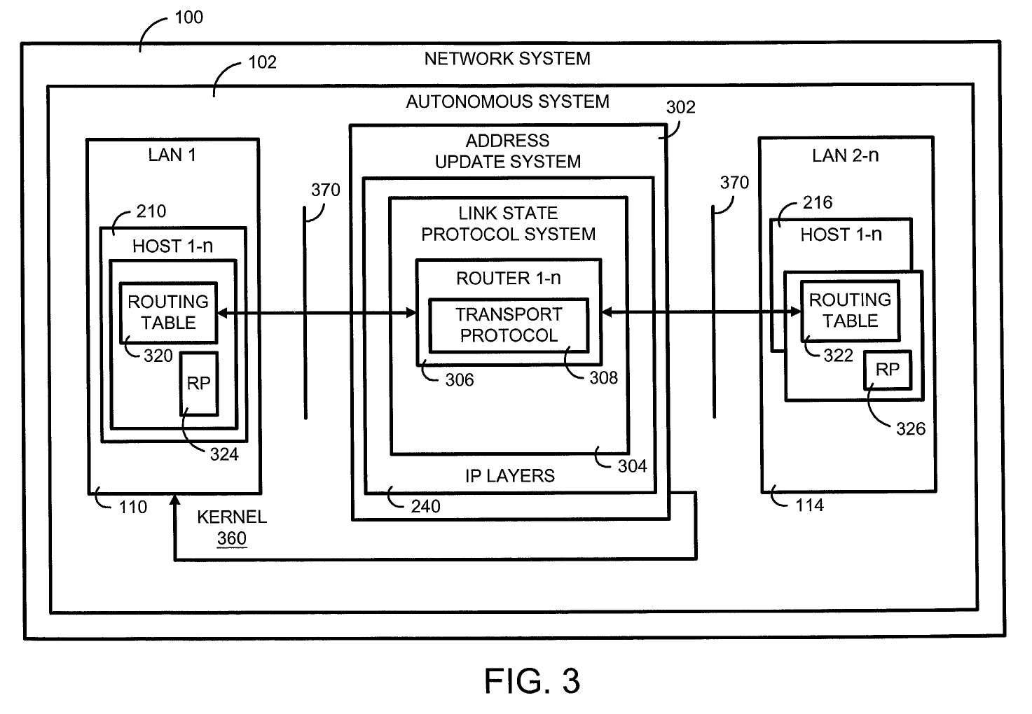

FIG. 3 is a block diagram illustrating the address update system 302.The host 1-n 210, 216 contains routing tables 320 and 322 respectively, used to determine which physical interface address to use for outgoing IP datagrams. Once this table has been consulted the ARP cache 1-n 214, 220 will be consulted to determine the physical address.

If the host 1-n 210, 216, receives an IP datagram on any interface it will pass it to the relevant application if it was for that host, or will attempt to retransmit it on one or other of the available interfaces if it was addressed to another host. Datagrams travel from host to host via gateways called routers. A router is generally, any machine responsible for making decisions about which of several paths network traffic will follow based on a network level address. When used with TCP/IP, the term refers specifically to an IP gateway that routes datagrams using IP destination addresses. In a TCP/IP internet, each IP gateway is a router because it uses IP destination addresses to choose routes.

A gateway is a special purpose, dedicated computer that attaches to two or more networks and routes packets from one to the other. In particular, an IP gateway routes IP datagrams among the networks to which it connects. Gateways route packets to other gateways until they can be delivered to the final destination directly on one physical network. The term is commonly used to apply to any machine that transfers information from one network to another, as in mail gateway.

Routers can talk to adjacent routers, informing each other of what the routers in all the networks in the AS 102 are currently connected to. The routers must communicate using a routing protocol, routing daemon, which updates the kernel's 360 routing table 320 with information received from neighbor routers. This dynamic communication aids the address update system 302.

The kernel 360 searches its routing table 320 for host routes, network routes and default routes. Host routes route packets to individual hosts, networks routes route packets to the specific network, which can have multiple hosts and default routes are predefined routes that are invoked when the destination does not match any of the preexisting host or network routes. What changes is the information placed in the routing table 320, of routes added and deleted dynamically, as routes change over time. If the routing daemon finds multiple routes to a destination, it chooses the best route to insert in the kernel's 360 table 320, and if a route has gone down it can delete the affected route or add an alternate.

Routers 1-n 306 use a transport protocol 308 to maintain the link state protocol system 304. UDP and TCP are protocols that could support the transport protocol 308 although UDP (User Datagram Protocol) applies to multicasting, where it makes sense for an application to send a single message to multiple recipients.

Each AS 102 has a routing protocol (RP) 324 to communicate between routers. Interior gateway routing protocols (IGP) include RIP and OSPF. A router supporting a dynamic RP should support the others. When the routing daemon starts it determines the interfaces 370 that are up and sends a request packet out each interface asking for the other routers' 1-n 306 complete routing table. If the reply has the correct address the request has been received, (if the metric is 16 indicating no route to that destination the response is returned). The response is validated and may update the routing table 320. New entries can be added, existing entries can be modified or deleted. Every 30 seconds, all or part of the of the routers' 1-n 306 entire routing table is sent to every neighbor router. Whenever the metric for a route changes it triggers an automatic update. In this manner all hosts 1-n 210,216, are linked to receive data through the AS 102.

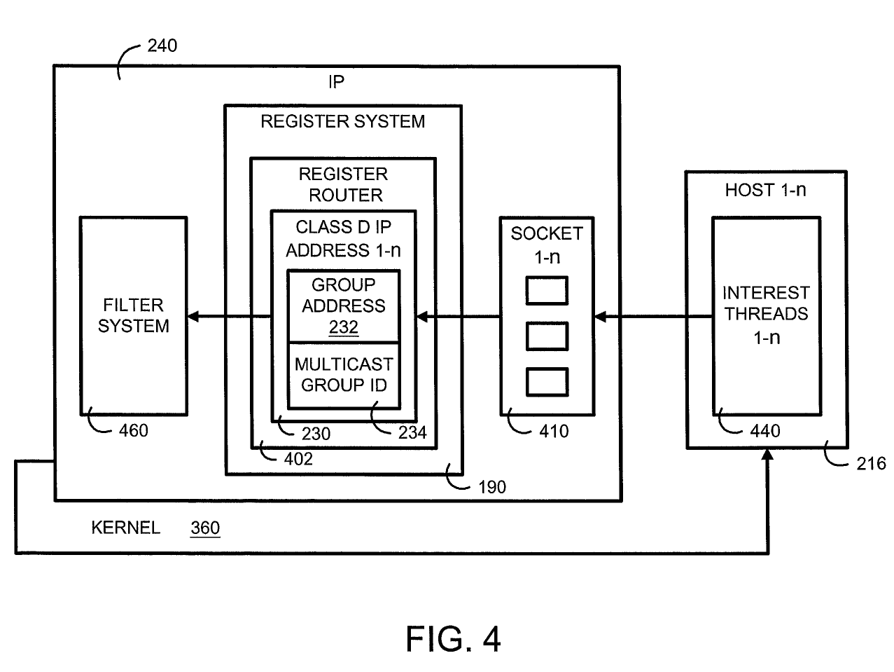

FIG. 4 is a block diagram of the stream register system that is a preferred embodiment of the current invention that delineates the specific data each host 1-n 210, 216 wishes to receive. This interest has to be recorded in the register router 402 in the register system 190. The computer host 1-n 216 has the data type it wishes to receive in a plurality of interest threads 1-n, 440. Interest threads 440 may represent bandwidths or other parameters that may define the data. The sockets 1-n, 410, provide parallel data transferability to multiple users with different streams of interest.

The interest threads 1-n, 440, are transported through the sockets 1-n, 410, to the register router 402. The register router 402 may employ the Internet Group Management Protocol (IGMP), or some such other suitable protocol for hosts and routers that support multicasting. Once a group address is established, each host 1-n, 216 establishes an interest thread “address” by combining the group address (in a preferred embodiment this is the class D IP address 1-n, 230) with the identifier representing the streams of interest. In other words, if there are multiple users on the host interested in different streams, the identifier corresponding to the streams are combined into a single identifier and used along with the group address to uniquely identify the hosts' interest thread.

In the IGMP format, there is a 64 bit header with two 32 bit parts. One of 32 bit parts corresponds to the IP multicast group ID 234. The other 32 bit part corresponds to 4 bit IGMP version, a 4 bit IGMP type, a 16 bit checksum and an unused 8 bit portion. This unused portion can carry the identifier representing the interest thread. In other words, the unused portion is available to register interest threads 1-n, 440.

The register system 190 is part of the IP layer 240, and this layer also includes a filter system 460. Based on the adjacent routers/hosts registered streams of interest, the filter system 460 forwards only relevant data. For example, if a particular adjacent router is interested in streams 1 (text) and 3 (audio) out of possible streams 1-4 (text, images, audio, video), it only forwards streams 1 and 3. The filter system 460 may be a fixed filter style in that one reservation is created for each interest thread 1-n 440 specified. This reservation based on bandwidth is used to send data efficiently with the filter system. If the system has a number of reservations from various hosts for the same interest thread the system will be able to respond to that homogeneous group simultaneously.

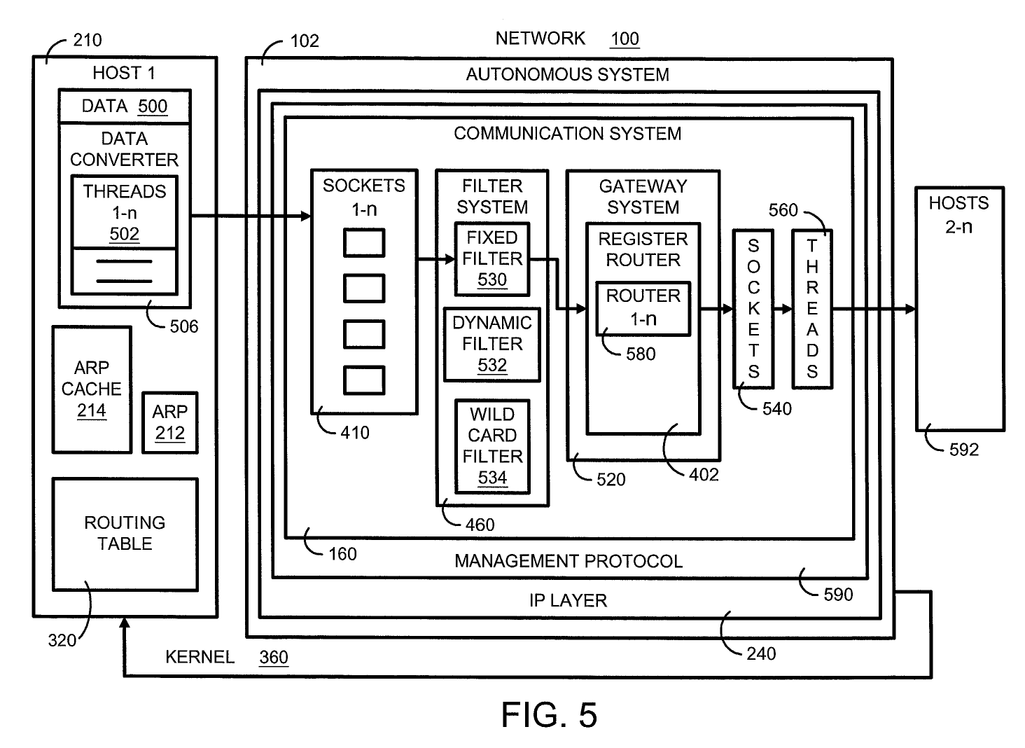

FIG. 5 is a block diagram illustrating the flow of data in a preferred embodiment of the current invention. Complications can occur when multiple networks such as the autonomous system 102, are involved in the passage of multicast datagrams through routers. A management protocol 590, such as the Internet Group Management Protocol (IGMP), could be used by hosts 1-n, 210, 216, and routers that support multicasting. It lets all systems on a physical network know which hosts currently belong to which multicast groups. This information is required by the multicast routers so they know which multicast data 500 to forward to which interfaces. IGMP is considered to be a part of the IP layer and its messages are transmitted as IP datagrams, in this example interest threads 1-n, 502.

When host 1, 210 boots up, the ARP 212, ARP cache 214, and the routing table 320, update the IP addresses of the AS 102 group members. The IP address may include the regular flags associated with routing tables, and in addition may have a flag indicating an interest thread 1-n, 440, developed at the register router 402. In this example, host 1 210 is to send data 500 to hosts 2-n, 592. The data 500 initially passes through the data converter 506 and forms datagrams, threads 1-n, 502. The threads are transferred to the communication system 160, through the IP layer 240 and management protocol 590.

The sockets 410 communicate with the filter system 460, which includes a fixed filter 530, dynamic filter 532, and a wild card filter 534. In a preferred embodiment of the invention the threads are filtered by the fixed filter, but the invention is not limited to this filter or any other filter system. The filter system 460 aligns threads 502 with addresses in the register router 402 in the gateway system 520. The register router 402 has routers 1-n so that a variety of pathways are available to ensure that the data 500 flows in a meaningful manner to the hosts 2-n, 592.

III. Working Example

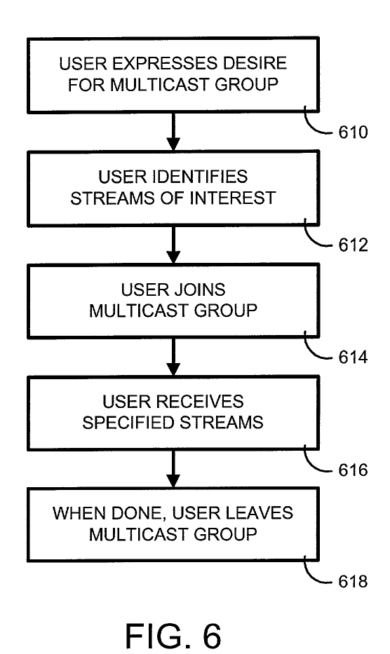

FIG. 6 is a general flow diagram of a working example of the present invention. There are numerous ways to implement the present invention, thus, the working examples illustrated in FIGS. 6-8 are shown for illustrative purposes only. FIGS. 6-8 are shown in an Internet environment that uses multicasting to deliver a media stream (as a video or audio stream), such as a live event or prerecorded event, to Internet uses.

In general, first, a user expresses his/her desire to enter a multicast group (step 610) controlled by the multicasting system 102 of FIG. 1. Second, the user identifies his/her particular streams of interest (step 612) to the multicasting system 102. Third, the user joins the desired multicast group (step 614). Fourth, the user receives specified content streams based on the user's identified streams of interest (step 616). When the user is done observing the stream, the user leaves multicast group (step 618).

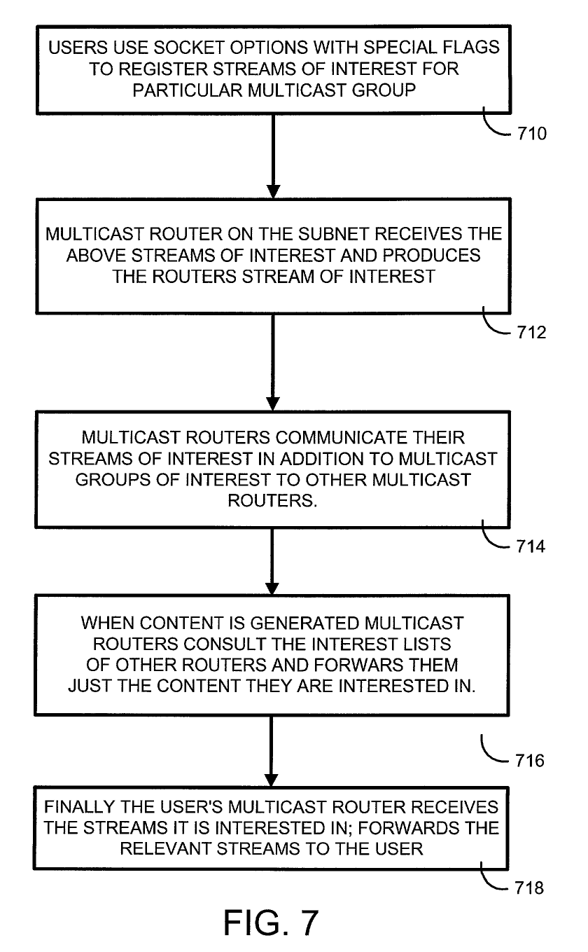

FIG. 7 is a detailed flow diagram of a working example of the present invention. Referring to the description of FIG. 6 above, in particular, first, users of the multicast system 102 can use socket options (with special flags) to register streams of interest for particular multicast groups (step 710). Second, a multicast router that is located on the subnet receives the above streams of interest, makes a note, and then adds it to its list of streams of interest (by analyzing all such user multicast requested streams).

This will produce the particular router's stream of interest (step 712). By extending (or slightly expanding) current protocols, such as IGMP, multicast routers can communicate their streams of interest in addition to multicast groups of interest to other multicast routers. As a result, the relevant routers will have information about the interests of other routers (step 714).

Next, when content is generated, multicast routers consult the interest lists of other routers (which has been exchanged previously) and forwards users just the content they are interested in viewing. These routers do the same for other routers and so on (step 716). Last, respective users' multicast routers receive the streams their users have indicated that are is interested in and forwards the relevant streams to the user (step 718).

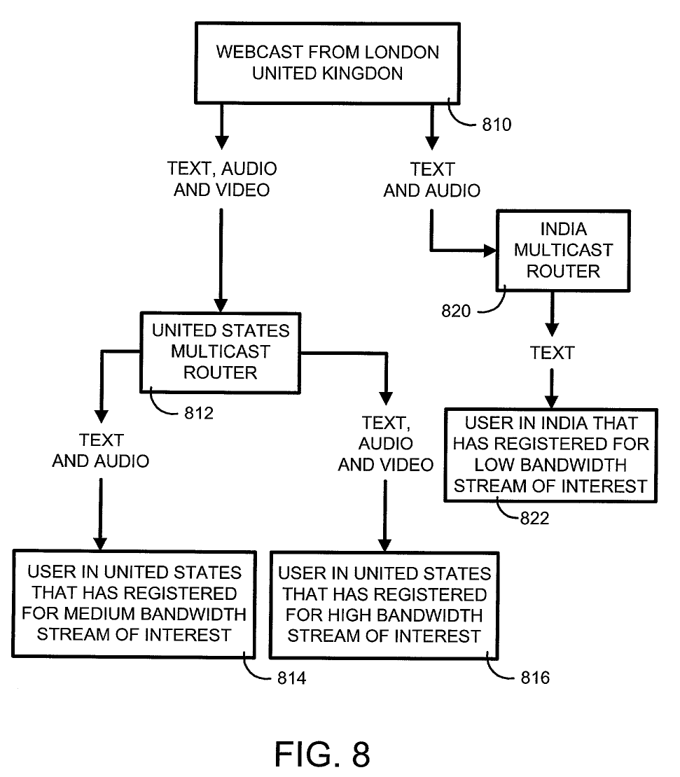

FIG. 8 is a block diagram illustrating a practical working example in an Internet environment in accordance with the present invention. In this example, an Internet multimedia webcast 810 is transmitted across the world via the Internet, originating from London, United Kingdom. Certain countries, depending on their capabilities and infrastructure, receive all or only portions of the webcast.

For instance, a multicast router 812 in the United States, which has excellent bandwidth infrastructure, would receive the entire webcast, including text, audio and video. However, a multicast router 820 in India, which has limited bandwidth infrastructure, would receive a portion of the webcast, such as only text and audio. At this point, the webcast, or portions of it, can be appropriately sent to users of the respective countries, depending on their specified steam of interest, as discussed above.

For example, users in the United States that have registered for medium bandwidth streams of interest will receive only pre-designated streams that are associated with medium bandwidth constraints, such as only text and audio 814. Next, users in United States that have registered for high bandwidth streams of interest will receive only pre-designated streams that are associated with high bandwidth constraints, such as the full webcast, including text, audio and video 816. Last, users in India that have registered for low bandwidth streams of interest will receive only pre-designated streams that are associated with low bandwidth constraints, such as the a limited webcast, including maybe only text 822.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for multicasting content to remote users, comprising:
designating a portion of the content to each one of plural multicast routers;
registering a data stream of interest for each user;
associating each user with a multicast router that geographically corresponds to the particular user and the data stream of interest registered by the particular user; and
transmitting the content to the users via the multicast routers.

2. The method of claim 1, wherein the content is delivered hierarchically from a host sever at a top level that controls the entire portion of the content to the plural multicast routers at a mid level that receive the designated portions of the content that they are capable of accommodating to the users at a lowest level which receive parts of the designated portions representing respective user registered data streams of interest.

3. The method of claim 1, wherein registering the data stream of interest includes requesting a user to identify the user's particular streams of interest to the multicasting system.

4. The method of claim 1, further comprising using network socket options with special flags to register streams of interest for particular multicast groups.

5. The method of claim 1, further comprising locating a multicast router on a subnet for receiving identified streams of interest and adding the streams of interest to the located router's list of streams of interest.

6. The method of claim 1, further comprising communicating the router's streams of interest to multicast groups of interest and to other multicast routers to allow relevant routers on the network to have information about the streams of interests of other routers.

7. The method of claim 6, further comprising examining the streams of interest lists of other routers and forwarding users content based on their identified streams of interest.

8. The method of claim 1, wherein the network is the Internet.

9. The method of claim 8, wherein the content includes at least one of audio and video Internet multimedia broadcast.

10. In a computer network system, a method for providing content from a host server to remote network users that connect to the network with different bandwidths, the method comprising:
establishing group membership for a multicast group;
establishing an individualized set of broadcast criteria;
disseminating broadcast data within the group into discrete segments; and
determining which segments of the broadcast data will be sent to remote servers of the network.

11. The method of claim 11, wherein establishing an individualized set of broadcast criteria includes registering streams of interest of the host.

12. The method of claim 10, further comprising using network socket options with special flags to register streams of interest for particular multicast groups.

13. The method of claim 10, further comprising communicating the router's streams of interest to multicast groups of interest and to other multicast routers to allow relevant routers on the network to have information about the streams of interests of other routers.

14. The method of claim 13, further comprising examining the streams of interest lists of other routers and forwarding users content based on their identified streams of interest.

15. The method of claim 10, wherein the network is the Internet.

16. In a computer network system, a multicast system for providing personalized content from a host server to remote network users that connect to the network with different bandwidths, the multicast system comprising:
plural multicast routers designated with portions of the content, wherein each multicast router registers data streams of interest for each user geographically associated with that multicast router and wherein the host server transmits the content to the users via the multicast routers.

17. The multicast system of claim 16, wherein the multicast routers are located on a subnet for receiving requested streams of interest.

18. The multicast system of claim 17, wherein the multicast routers save the requested streams and then add the streams to their list of streams of interest.

19. The multicast system of claim 18, wherein the multicast routers communicate both their streams of interest and their multicast groups of interest to other networked multicast routers to allow all routers to have knowledge of other router's streams of interest within the network.

20. The multicast system of claim 16, wherein the network is the Internet.

21. A method using a computer-readable medium having computer-executable instructions for multicasting content originating from a host server to remote users, the method comprising:
designating a portion of the content from the host server to each one of plural multicast routers, wherein each designated portion is based on broadcasting capabilities of the respective multicast router;
registering a data stream of interest by each remote user;
associating each remote user with a multicast router that corresponds to a geographical locale and the data stream of interest registered by the particular user; and
transmitting the content to the remote users via the multicast routers.

22. The method of claim 21, wherein the content is delivered hierarchically from the host sever residing at a top level to the plural multicast routers residing at a mid level to the users residing at a lowest level.

23. The method of claim 22, wherein the multicast routers receive the designated portions of the content that they are capable of accommodating and the remote users receive parts of the designated portions representing respective user registered data streams of interest.

24. The method of claim 21, wherein registering the data stream of interest includes requesting a remote user to identify the user's particular streams of interest and reception capabilities to the multicasting system.

25. The method of claim 21, further comprising using network socket options with special flags to register streams of interest for particular multicast groups.

26. The method of claim 21, further comprising locating multicast routers on a subnet for receiving identified streams of interest and adding the streams of interest to the located router's list of streams of interest.
